(19) United States
(12) Patent Application Publication
(10) Pub. No.: US 2023/0288932 A1
(43) Pub. Date: Sep. 14, 2023

(54) DYNAMIC AUTOMATIC UNPARKING

(71) Applicant: Ford Global Technologies, LLC, Dearborn, MI (US)

(72) Inventors: Timothy C. Bettger, Aachen (DE); Thomas Gerlitz, Aachen (DE); Douglas Blue, Plymouth, MI (US); Ahmed Benmimoun, Aachen (DE); Nadja Wysietzki, Koeln (DE); Lars Kuhnert, Köln (DE); Erick Michael Lavoie, Van Buren Charter Township, MI (US)

(73) Assignee: Ford Global Technologies, LLC, Dearborn, MI (US)

(21) Appl. No.: 17/654,064

(22) Filed: Mar. 8, 2022

(51) Int. Cl. G05D 1/02; G05D 1/00

(52) U.S. Cl. CPC G05D 1/0212; G05D 1/0274; G05D 1/0011; G05D 2201/0213

(57) ABSTRACT

A method is provided for the automatic unparking of a motor vehicle, with which a parking trajectory is determined on the basis of directly collected data about the motor vehicle surroundings and additionally on the basis of data relating to the motor vehicle surroundings and obtained during the movement of the motor vehicle to the parking position and stored on a memory device of the motor vehicle. A motor vehicle and a system for carrying out the method will also be provided.

### FIELD

The invention relates to a method for the automatic unparking of a motor vehicle as well as a motor vehicle and a system for carrying out the method.

### BACKGROUND

In modern motor vehicles, systems are often used to support parking and unparking, in brief parking assistance systems. There are parking assistance systems that can perform the entire parking process automatically. With the appearance of autonomous vehicles, automatic parking assistance systems will also be more common. Parking assistance systems can assist a parking process by taking over the steering (semi assisted parking, SAP) or can perform it completely by taking over the steering, acceleration, braking and shifting (fully assisted parking, FAP). The driver has a monitoring function within the motor vehicle and, for example, keeps a button pressed which is associated with the parking, by means of which it can immediately stop the parking process by releasing it.

Another option is parking with remote control, which corresponds to the FAP but is controlled by the driver from outside the vehicle, for example by means of a smartphone on which a corresponding app is installed. In doing so, for example a button or a field on a touch screen associated with parking is also pressed, by means of which the driver can immediately stop the parking process by releasing it. The most common use for parking with remote control is parking in and unparking from parking spaces that are too narrow for convenient opening of the motor vehicle doors. In this way, boarding and disembarking can take place at a different, more convenient place. Parking with remote control is disclosed, for example, in the documents US 2016/240080 A1, U.S. Pat. No. 7,053,795 B2 and U.S. Pat. No. 8,558,690 B2. Documents US 2016/152258 A1 and EP 2 687 410 A1 also disclose methods by which, especially when unparking with remote control, obstacles occurring in the planned trajectory can be reacted to. The object is to improve the methods of the prior art.

### SUMMARY

The embodiments of the invention can be combined with each other in an advantageous manner.

A first aspect of the invention concerns a method for the automatic unparking of a motor vehicle, with the steps:
Issuing a first control command to move the motor vehicle from a current parking position to a target position,
Recording the surroundings of the motor vehicle relevant to the movement of the motor vehicle from the parking position,
Issuing a second control command to select the direction of movement and the angle of movement from the parking position,
Identifying at least a first trajectory for an unparking movement from the parking position to the target position,
Starting the unparking movement.

The method is characterized in that the first trajectory is additionally determined on the basis of data relating to information about the motor vehicle surroundings, determined during a movement of the motor vehicle to the parking position and stored on a memory device of the motor vehicle. In other words, the calculation of the first trajectory incorporates information directly, i.e. currently obtained information and, if possible, stored information.

The method according to the invention is advantageous because it allows forward-looking planning of a trajectory for the automatic unparking of a remotely controlled motor vehicle. The information is recorded by radar, ultrasound, lidar and/or a camera without being limited thereto. Furthermore, the method allows dynamic adaptation for obstacles that appear in the trajectory already being driven. The method is preferably started, monitored, and terminated by means of an intelligent control device, for example a smartphone with memory and one or more processors on which a corresponding app is installed.

Preferably, the first trajectory is divided into multiple sub-trajectories. This is particularly advantageous in the vicinity of an intersection area, where several back and forth maneuvers must be carried out in order to counteract the risk of a collision with other road users. However, it is also advantageous in the area of other obstacles or on narrow roads. The planned sub-trajectories can be displayed to the driver (the user of the method) on a display, wherein he can determine the maximum number of movements and the time to unpark. Preferably, the number of sub-trajectories and the time of the unparking movement are limited. Advantageously, as a result potential traffic is not hindered unnecessarily. Furthermore, the driver can be given several positions to choose from at which the motor vehicle is to come to a halt.

Preferably, the information about the surroundings of the motor vehicle concerns the width of the roadway on which the motor vehicle will be moved. Advantageously, this information has been included because road widths can change along the length of a road, i.e. for example, may be wider in the immediate viewable area than in the targeted area in which the motor vehicle comes to a halt at the end of the unparking process. This information is more advantageously already stored before unparking with the method.

Preferably, the information about the surroundings of the motor vehicle concerns the distance to an intersection of the roadway on which the motor vehicle will be moved. Advantageously, the trajectory can be planned for unparking without entering or getting too close to the intersection area. As described above, the unparking trajectory can be planned in several sub-trajectories with several changes of direction, for example to avoid the intersection area.

Preferably, a ring memory is used as a memory device in the method. The information is stored over a certain period of time and/or a certain distance travelled. Particularly preferably, the data about the ring memory are transcribed onto a non-volatile memory device when switching off the motor vehicle. As a result, the information can be advantageously accessed if the motor vehicle is on the parking position beyond the specified period. Here, non-volatile memory devices are hard drives in the motor vehicle or the control device or a cloud, for example.

Preferably, information about other motor vehicles moving into the area of the first trajectory is included in the method. Movements of motor vehicles can be detected, which are already moving in a certain direction in the planned trajectory. Furthermore, information about planned movements of another motor vehicle in a certain direction can be detected, for example via activated indicators and/or vehicle-to-vehicle communications. The information may come directly from the user, who in certain situations has more overview of the traffic situation than can be achieved with the equipment of the user's motor vehicle. Advantageously in this case, blocking the path of the other motor vehicle or a potential collision is counteracted.

Preferably, in addition to the first trajectory, at least a second trajectory is determined and one of said trajectories is selected by a user. In this case, the direction, the angle of movement for exiting from the parking space relative to the limits of the parking space (for example other vehicles, walls, or curbs) as well as the desired lane and/or target position and orientation can be selected as the user pleases. The above statements regarding the first trajectory then apply accordingly to the other selected trajectories.

A second aspect of the invention concerns a motor vehicle with at least one detection device for detecting the surroundings of the motor vehicle, selected from the group containing radar, ultrasound, lidar and a camera, a memory device, and a control device. The control device is configured to control a method according to the invention. The advantages of the motor vehicle correspond to the advantages of the method according to the invention.

A third aspect of the invention concerns a system consisting of a motor vehicle according to the invention and an intelligent device with an app that allows remote control for starting and carrying out a method according to the invention.

### BRIEF DESCRIPTION OF THE DRAWINGS

The invention is explained in more detail on the basis of the figures. In the FIGS.

FIG. 1 shows a schematic representation of an embodiment of the motor vehicle according to the invention

FIG. 2 shows a flow diagram of an embodiment of the method according to the invention.

FIG. 3 shows a schematic representation of a parking maneuver.

FIG. 4 shows a schematic representation of another parking maneuver.

FIG. 5 shows a schematic representation of another parking maneuver.

FIG. 6 shows a schematic representation of another parking maneuver.

### DETAILED DESCRIPTION

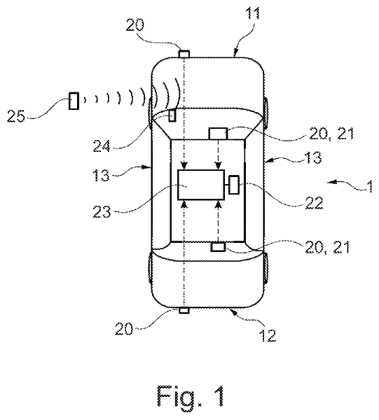

The systems and methods described herein may be implemented via a computer, such as a controller, a memory, and/or a processor or the like in a mobile device (e.g., a smartphone), a vehicle, or over a network. The computer may be part of a mobile device, a vehicle, and/or in the cloud. In FIG. 1 a first motor vehicle 1 is shown. The motor vehicle 1 has a motor vehicle front 11, a motor vehicle rear 12 and two sides 13. In the area of the motor vehicle front 11, the motor vehicle rear 12 and/or the sides 13, in each case at least one detection device 20 for the detection of obstacles and for distance measurement is arranged, which may be, for example, a radar, ultrasound, camera 21 or lidar, without being limited thereto.

The first motor vehicle 1 also has a memory device 22, which is designed to receive and store information from the detection device 20. The memory device 22 is designed as a ring memory. The first motor vehicle 1 also has a control device 23, which is designed to receive information from the detection device 20, to process it and to issue control commands to the steering system of the wheels 11, the brakes, the gearbox, or the engine of the motor vehicle. In addition, the control device 23 can also call up information from the memory device 22 and process it accordingly. The control device can also call up information from an external memory, such as a cloud.

Furthermore, the first motor vehicle 1 has a receiving device 24, which is designed to receive control commands of a remote control device 25. The remote control device 25 can be a smartphone 25, on which an app is installed, whereby the driver of the first motor vehicle 1 (or another user) can issue commands to perform a parking maneuver and can intervene if necessary.

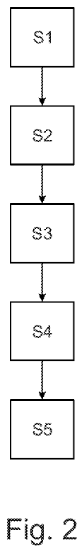

In a method for the automatic unparking of the first motor vehicle 1 according to FIG. 2, in a first step S1 a first control command is issued for moving the first motor vehicle 1 from a current parking position P to a target position Z. In a second step S2, the detection device 20 detects the surroundings of the first motor vehicle 1, which is relevant for a movement of the motor vehicle from the parking position in the selected direction. This information is transmitted to the control device 23. Step S2 also incorporates information taken during the outward journey to the parking space, so that an image of the parking surroundings can be created that goes beyond the area immediately visible with the facilities of the first motor vehicle 1.

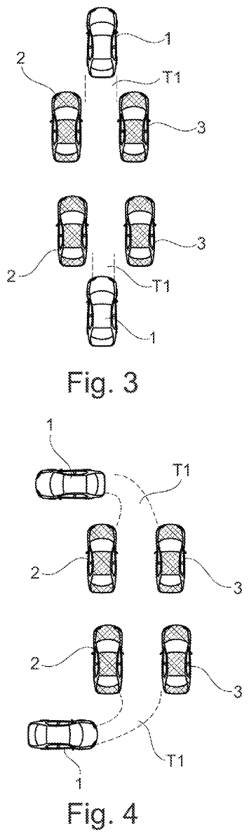

In a third step S3, a second control command is issued by the driver of the first motor vehicle 1 via an app on the smartphone 25. The driver selects in which direction the vehicle should unpark. In FIGS. 3-6 the first motor vehicle is located between a second motor vehicle 2 and a third motor vehicle 3 in a parking space which may be too narrow for boarding and from which the first motor vehicle 1 is to unpark automatically. In a step-by-step selection, for example by selecting alternatives from a list, it is determined in three sub-steps whether the motor vehicle 1 should unpark forwards (FIGS. 3, 4 and 5 at the top) or backwards (FIGS. 3, 4 and 5 at the bottom) (sub-step 1) and in which orientation (sub-step 2)—straight from the parking space (FIG. 3), to the left

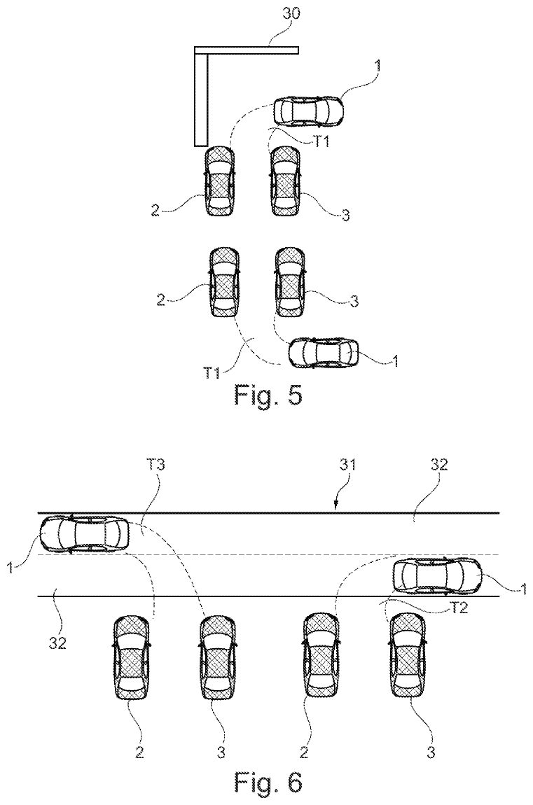

(FIG. 4) or to the right (FIG. 5), and at which angle (sub-step 3). Alternatively, the selection of the direction can also be made in one step by selecting by a swipe or a tap in a selection of alternatives shown in a graphical representation on a touch screen of the smartphone 25. Only the directions that can be reached are offered.

The control device 23 determines a first trajectory T1 for an unparking movement in a fourth step S4 on the basis of the instruction received in S1 and the information received in step S2. The first trajectory T1 corresponds to a projected route from a parking position P to a target position Z. The control device 23 transmits control commands to the steering, brakes, transmission, and drive of the first motor vehicle 1 according to the trajectory T1. Several trajectories can also be identified, from which the driver of the first motor vehicle 1 can select one. Furthermore, for example, obstacles are also detected, and a single possible trajectory is proposed accordingly, for example if the movement is for example limited by a wall 30 (or a house wall or similar) (FIG. 5, above). Near an intersection area, the first trajectory T1 can be divided into several sub-trajectories if the first trajectory touches the intersection area. The driver can select the number and direction of the sub-trajectories on a display on the screen of the smartphone 25.

When unparking on a roadway 31 which has several lanes 32 (FIG. 6), the target position Z can be a different distance from the parking position depending on the chosen trajectory. The lane onto which the driver will unpark can be selected by the driver, so that he chooses the second trajectory T2 or the third trajectory T3, for example by touching the touchscreen of the smartphone 25. Alternatively, automatic selection can be performed on the basis of map information about a designated route according to the optimal roadway direction.

In a fifth step S5, the unparking movement is started and executed along the selected trajectory, for example the first trajectory T1. The start is carried out by means of a start signal issued by the driver by means of the remote control 25. The potential route along the first trajectory T1 is recorded by the detection device 20. If an obstacle enters, especially in the form of another motor vehicle or other road user, the movement is stopped. If the obstacle disappears, the movement continues along the first trajectory T1. Alternatively, an evasive trajectory can be determined and executed in front of the control device 23, which moves the motor vehicle to the target position Z, bypassing the obstacle.

The obstacle may also appear indirectly. In this case, for example, a set indicator of another motor vehicle which indicates a movement in a certain direction which would cross the selected trajectory may be detected by means of the detection device 20. An intended movement of a motor vehicle can also be mediated by a motor vehicle-to-vehicle communication. In any case, the movement of the first motor vehicle 1 in the selected trajectory T1 would be stopped until it is clear that the route is free and remains free.

### REFERENCE CHARACTER LIST

1 first motor vehicle
2 second motor vehicle
3 third motor vehicle
11 vehicle front
12 vehicle rear
13 side of the vehicle
20 detection device
21 camera
22 memory device
23 control device
24 receiving device
25 transmitting device
P parking position
Z target position
T1 first trajectory
T2 second trajectory
T3 third trajectory

1. A method for the automatic unparking of a first motor vehicle (1), with the steps:
issuing a first control command to move the motor vehicle (1) to a parking position (P),
recording the surroundings of the motor vehicle (1) relevant to the movement of the motor vehicle to the parking position (P),
issuing a second control command to move the motor vehicle (1) from a current parking position (P) to a target position (Z),
recording the surroundings of the motor vehicle (1) relevant to the movement of the motor vehicle from the parking position (P),
issuing a third control command to select the direction of movement and the angle of movement from the parking position (P),
determining at least one first trajectory (T1) for an unparking movement from the parking position (P) to the target position (Z), and
starting the unparking movement,
wherein the first trajectory (T1) is additionally determined on the basis of data relating to the motor vehicle surroundings recorded during the movement of the motor vehicle (1) to the parking position (P), and is stored on a memory device (22) of the motor vehicle (1).

2. The method according to claim 1, wherein the first trajectory (T1) is divided into several sub-trajectories.

3. The method according to claim 2, wherein the number of sub-trajectories and the time of the unparking movement are limited.

4. The method according to claim 1, wherein the information about the surroundings of the motor vehicle relates to the width of the roadway (31) on which the motor vehicle (1) will be moved.

5. The method according to claim 1, wherein the information about the surroundings of the motor vehicle relates to the distance to an intersection area of the roadway (31) on which the motor vehicle (1) will be moved, and wherein the first trajectory is selected to avoid the intersection area.

6. The method according to claim 1, wherein a ring memory is used as the memory device (22).

7. The method according to claim 6, wherein when the motor vehicle (1) is switched off, the data on the ring memory (22) are transcribed to a non-volatile memory device.

8. The method according to claim 1, wherein additionally information about further motor vehicles which move into the area of the first trajectory (T1) is taken into account.

9. The method according to claim 1, wherein the method is started by means of a remote control (25).

10. The method according to claim 1, wherein in addition to the first trajectory (T1) at least a second trajectory (T2) is determined and one of said trajectories (T1, T2) is selected.

11. The method according to claim 10, wherein one of said trajectories (T1, T2) is selected without user input.

12. A motor vehicle (1) with at least one detection device for detecting the surroundings of the motor vehicle (20), selected from the group including radar, ultrasound, lidar and a camera (21), a memory device (22) and a control device (23), wherein the control device (23) is configured to:
issue a first control command to move the motor vehicle (1) to a parking position (P),
record the surroundings of the motor vehicle (1) relevant to the movement of the motor vehicle to the parking position (P),
issue a second control command to move the motor vehicle (1) from a current parking position (P) to a target position (Z),
record the surroundings of the motor vehicle (1) relevant to the movement of the motor vehicle from the parking position (P),
issue a third control command to select the direction of movement and the angle of movement from the parking position (P),
determine at least one first trajectory (T1) for an unparking movement from the parking position (P) to the target position (Z), and
start the unparking movement,
wherein the first trajectory (T1) is additionally determined on the basis of data relating to the motor vehicle surroundings recorded during the movement of the motor vehicle (1) to the parking position (P), and is stored on a memory device (22) of the motor vehicle (1).

13. A system of a motor vehicle according to claim 12, wherein the first control command and the second control command are received from an application of an intelligent device.
